(19) United States
(12) Patent Application Publication
(10) Pub. No.: US 2012/0101870 A1
(43) Pub. Date: Apr. 26, 2012

(54) Estimating the Sensitivity of Enterprise Data

(75) Inventors: Stephen Carl Gates, Hawthorne, NY (US); Youngja Park, Hawthorne, NY (US); Josyula R. Rao, Hawthorne, NY (US); Wilfried Teiken, Hawthorne, NY (US)

(73) Assignee: International Business Machines Corporation, Armonk, NY (US)

(21) Appl. No.: 12/910,587

(22) Filed: Oct. 22, 2010

(51) Int. Cl. G06F 17/30; G06Q 10/00

(52) U.S. Cl. 705/7.28; 707/740; 707/709; 707/E17.09; 707/E17.108

(57) ABSTRACT

A method for evaluating data includes defining a list of data categories, determining a relative sensitivity to each data category, determining one or more classifiers for each of the data categories, receiving a plurality of data items to be valued, determining one of the data categories for each of said plurality of data items according to the one or more classifiers, and determining a respective sensitivity for each of said plurality of data items.

### BACKGROUND OF THE INVENTION

1. Technical Field

The present disclosure relates to a system and method for semi-automatically estimating the sensitivity of data in an organization. More specifically, the present disclosure describes methods for estimating the risk to a business posed by the potential loss, exposure, or alteration of the data items.

2. Discussion of Related Art

Data typically is a key asset within modern enterprises. Loss, exposure, or alteration of that data may cause damage to the enterprise; this damage can include tangible effects (such as loss of business or loss of competitive advantage) or intangible effects (such as loss of reputation), but in any case, the effects can be severe or even catastrophic. The aggregate of the tangible effects and intangible effects of data loss, exposure or alteration we term the sensitivity of the data. Hence, businesses typically make a variety of efforts to safeguard their data, such as systems for content management, data loss protection (DLP), and data backup systems. Unfortunately, these systems are often too expensive to apply to all data in an enterprise, or fail because enterprises do not have a clear idea of where their sensitive data resides.

As an example, consider systems for data loss protection (DLP) and data-centric security which are designed for safe-guarding important and sensitive data. The state-of-the-art technologies for DLP don't have any automated mechanisms to measure the sensitivity of individual data items, and thus treat all data equally. Most known DLP solutions rely on the following two approaches to identify sensitive data.

The first method is applying automatic or semi-automatic classification techniques to detect the content type of the given data (e.g., documents containing credit card information or social security numbers). Solutions using this method can determine if a document or a data item belongs to a certain category or contain a certain kind of information, but they do not measure the estimated sensitivity of individual data items. Therefore, these technologies provide the same kind and level of security measures to all data items belonging to a same category.

The second method is having human experts inspect the data in an organization and judge the importance levels of the data manually. This does allow more sensitive data to be better protected. However, the limitations of this method are: (1) it is very labor-intensive and costly, so typically only a few data types or data sources are inspected; (2) human judgments are very subjective and often qualitative and (3) human inspection may not be complete since it is very hard for people to have a complete view on all the data in a large organization. Furthermore, the manual method also does not typically account for data which moves after the data inspection process occurs.

In a similar fashion, other data-centric processes, such as case management, records management, data backup, and content management systems typically do not differentiate between data that is highly sensitive and data that is of low sensitivity to the enterprise.

Therefore, a need exists for a system for locating an enterprise's data, estimating a sensitivity of the data and protecting that data in proportion to its value or sensitivity for the enterprise.

### BRIEF SUMMARY

According to an embodiment of the present disclosure, a method for evaluating data includes defining a list of data categories, determining a relative sensitivity to each data category, determining one or more classifiers for each of the data categories, receiving a plurality of data items to be valued, determining one of the data categories for each of said plurality of data items according to the one or more classifiers, and determining a respective sensitivity for each of said plurality of data items.

A system for evaluating data includes a memory device storing a plurality of instructions embodying the system for evaluating data, and a processor for receiving a plurality of data items to be valued and a list of data categories and executing the plurality of instructions to perform a method including determining a relative sensitivity to each data category, determining one or more classifiers for each of the data categories, determining one of the data categories for each of said plurality of data items according to the one or more classifiers, and determining a respective sensitivity for each of said plurality of data items.

### BRIEF DESCRIPTION OF THE SEVERAL VIEWS OF THE DRAWINGS

Preferred embodiments of the present disclosure will be described below in more detail, with reference to the accompanying drawings:

FIG. 1 is a block diagram of a system for evaluating data sensitivity according to an embodiment of the present disclosure;

FIG. 2 is a flow diagram of a method of evaluating data sensitivity according to an embodiment of the present disclosure;

FIG. 3A is a diagram describing components for a data selection process according to an embodiment of the present disclosure;

FIG. 3B is a flow diagram for estimating the sensitivities of data in an organization according to an embodiment of the present disclosure;

FIG. 4 is a flow diagram of a method for determining a sensitivity level of a data item according to an embodiment of the present disclosure; and

FIG. 5 is a diagram of a computer system for estimating the sensitivities of data in an organization according to an embodiment of the present disclosure.

### DETAILED DESCRIPTION

The present disclosure describes embodiments of a system for locating an enterprise's data, estimating their sensitivity and protecting that data in proportion to its value or sensitivity for the enterprise.

According to an embodiment of the present disclosure, data sensitivity may be automatically or semi-automatically determined. Embodiments of the present disclosure may be incorporated into various other applications. Two exemplary applications include information technology (IT) security and smart storage. Data sensitivity can significantly enhance IT security of an organization, as organizations may objectively identify the sensitivity of data assets and adjust protection accordingly, e.g., providing increased protection for higher-sensitivity data assets. In another exemplary embodiment, one challenging task of a smart storage system is to create and manage storage backup intelligently. Since backing up all data in an enterprise requires a large amount of storage space and consumes computing time, a “smart” storage backup process may be implemented based on data sensitivity in which the sensitive data may be backed up more frequently, or in which the least sensitive data may never be backed up, thus saving significant amounts of storage space and computing time.

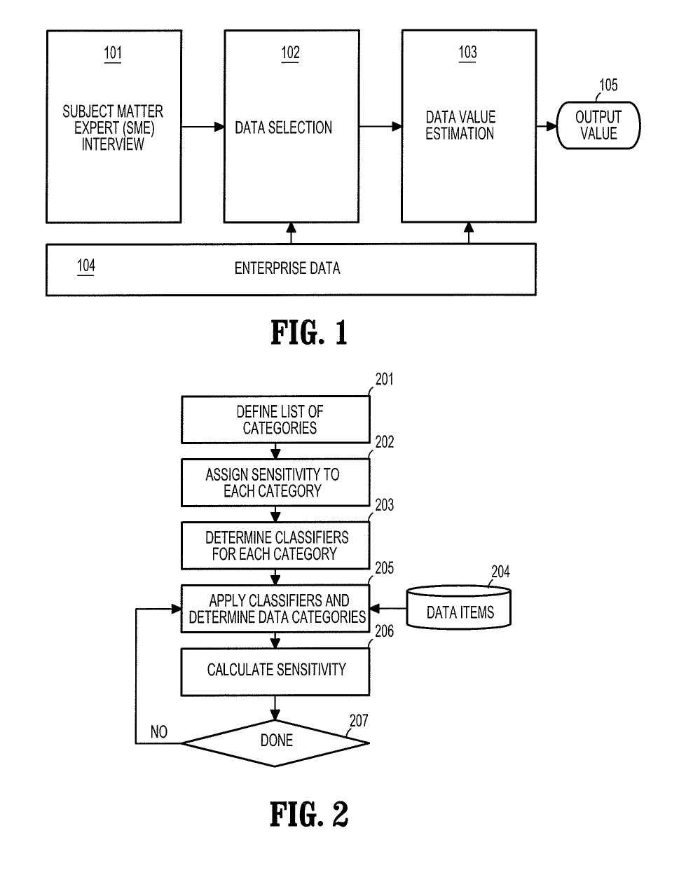

According to an embodiment of the present disclosure, an exemplary system includes an SME (Subject Matter Expert) interview (101), data selection (102) and data sensitivity estimation (103) components (see FIG. 1).

According to an embodiment of the present disclosure, an exemplary method (see FIG. 2) includes defining a list of data categories that are of interest to the enterprise (201) and assigning a relative sensitivity to each data category in the list of data categories (202) determining a classifier for each of the data categories in the list of data categories (203) that can identify a particular datum or set of data as belonging to a particular category; receiving a plurality of data items to be valued (204); determining one or more of the data categories for each of the plurality of data items (205); and calculating a sensitivity for each of the plurality of data items (206).

At block 201 the definition of a list of data categories may be accomplished in several ways. For example, the definition may be built by interviewing subject matter experts (SMEs) to determine which data categories are of interest, or it can be adapted from a pre-prepared industry-standard list, or adapted from an available industry taxonomy of data or processes. The list of data categories would typically include, as much as possible, a complete inventory of different data categories (high and low sensitivity) that may be encountered in the enterprise.

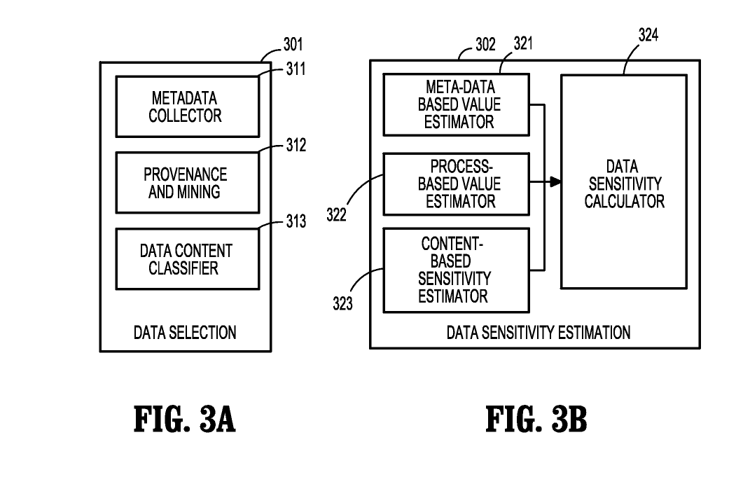

SMEs can also provide some initial (may not be complete) knowledge on a company's business. Referring to FIGS. 3A-B, data selection (301) identifies a subset of the enterprise data (104) that are potentially high-sensitivity. Data sensitivity estimation (302) measures the estimated sensitivity of individual data items.

The SME interview process (101) of measuring data sensitivity includes interactions with an SME. The role of the SME is to provide an initial view on data sensitivity (e.g., what is high-sensitivity data). For example, the SME can provide a list of business processes (e.g., insurance claim process), possible locations where data resides (e.g., customer DB, patents DB) and categories of sensitive data (e.g., customer personal information, new product development plan). This information may be utilized for data selection, e.g., for selecting higher-sensitivity data. The SME is expected to provide estimated sensitivities for sample data that can help build tools for data sensitivity estimation. The labels can include any of several ways of measuring the sensitivity, such as a categorical range of data sensitivity (e.g., low, medium, high with attendant thresholds), numeric ranks (e.g., decile or percentile), dollar amounts (e.g., $1M), or unitless arbitrary values (e.g., a scale from 1.0 to 10.0).

Another role of the SME is to provide feedback to automated components in the system of FIG. 1. For example, a business process provenance method can identify business processes, and the SME can select a subset of processes of interest. Another example includes a data content classification method may discover a new data category, and the SME can provide an estimated sensitivity for the new data category.

In a preferred embodiment, an SME interview tool (see 101 in FIG. 1) may be implemented to help the SME interact with the system. The tool may contain industry models that the SME can reference when building a company-specific model. Once a new company model is created, the model can be used to update the industry model it belongs to. The tool may display the categories in a hierarchy, and allow the SME to move the categories within the hierarchy to reflect their rank order, for example. It may also provide the SME the ability to annotate each category with reasons for assigning it a particular sensitivity, and it may provide means for additional information to be entered, such as how the sensitivity of the data varies with time (e.g., financial data that are much less sensitivity once a company's quarterly results are announced).

Referring again to FIGS. 3A-B, for a data selection method (301), the amount of data in a given organization can be large, where analyzing all the data items may not be feasible. In such a case the data selection method (301) may identify potentially high-sensitivity data in the company worthy of further analysis. Different characteristics of the company's business and the data types can be exploited. In a preferred embodiment, one or more of the following methods may be used to identify potentially data of interest, e.g., high-sensitivity data.

A metadata collector (311) collects metadata information of the enterprise data (see block 104 in FIG. 1) such as the author, the owner, the users, the creation time, last modified time, the physical location, etc. Some portions of the data may be filtered based on the metadata. For example, data may be discarded from further analysis if the data has not been used for a specified or predetermined period of time or if the number of users is small compared to a threshold.

Business process provenance and mining (312) identifies important business processes in the target organization, and the data items used for the identified processes. The business process provenance and mining (312) produces an end-to-end view of a business process including (all) subprocesses, data artifacts and human resources involved in the process. The business process provenance and mining (312) further discovers new processes or new insights on an existing process by mining activity logs generated by software systems.

The business process provenance and mining (312) (or business, process management tool) is used to analyze the business processes identified by SMEs in block 101 of FIG. 1. The output of the business process provenance and mining (312) is one or more directed graphs including processes, the relationship between processes and the data resources used in the processes. Data resources included in the processes are selected for further analysis. If the amount of selected data is still large, selected data may be reduced by choosing data used in more important (rare) processes.

For example, the system measures the priority level (e.g., importance) of the processes. This can be carried out manually or semi-automatically. In a manual approach, human experts inspect the process graphs generated by the business process provenance and assign business sensitivities to the processes. In a semi-automatic (more preferable) method, a tool automatically determines the importance levels of the processes (Process-Based Sensitivity Estimator (322, FIG. 3B)) by applying graph analysis techniques based on the dependencies of the processes and the data, and human experts confirm or correct the automatically suggested values. In a preferred embodiment, the process priority level is initially determined manually. After human experts produce manually generated process sensitivity data, a machine learning system is created using the manually generated data to make a prediction.

Data content classifiers (313) can determine data categories to which the data items belong using text and data mining technologies. For each data item (e.g., a email message or a document or a database table), the component conducts content analysis and classification to determine the document category. Documents belonging to less important categories such as personal emails with no sensitive entities may be discarded.

The enterprise data includes both structured data (e.g., databases) and unstructured data (e.g., document files, email messages, application logs). The input of the system can be at any granularity; an entire database, a record of a database, all data in a server or a laptop, or a single document. The method may be embodied as a set of software (SW) programs that identify data items valuable for a business, for regulation compliances including patent documents, new product plans, acquisition plans, personal information (e.g., social security number, credit card number, personal health information), etc. In this context, the software programs are classifiers. Classifiers are particular kinds of software programs, which assign an input data item into a pre-defined class. For example, a classifier may be used to answer a question such as what is the topic of this document? According to an embodiment of the present disclosure, the classifiers are software programs that are able to distinguish data from one data category (e.g., “acquisition plans”) from any data belonging to any other data category (e.g., “HR records”). These classifiers can be built using any of several methods well-known in the art, such as machine-learning classifiers trained with examples of each data category, or pattern-based classifiers that look for particular patterns of words or phrases in a document (e.g., all documents containing the string of “for your eyes only”).

At block 205, each of the data objects selected for classification is subjected to the set of classifiers, and the data category selected based on the scores from the set of classifiers. This selection is also a technique well-known within the art of data classification.

Data sensitivity estimation (302) measures the sensitivity of individual data items in an organization or in the selected data subset determined in block 301. Data sensitivity estimation (302) may be decomposed into components. These components may be built as machine learning-based classification or regression systems, or rule-based systems.

A metadata-based sensitivity estimator component (321) produces an importance value of data based on metadata information. For example, a data item created by an executive may be more important than a data item created by a regular employee. A data item used by many different organizations may have higher sensitivity than data items used by a few users in a same organization Similarly, a document last modified a few days ago is likely to be more important than a document modified several years back. These metadata are combined to estimate the sensitivity of a given data item.

A process-based sensitivity estimator component (322) automatically determines the importance levels of the processes by applying various graph analysis techniques. The predictors of process importance level include the business area the process is primarily used for, the number of in-degree links to the process node, the number of out-degree links, the frequency of the process being executed, the job roles of the humans involved in the process, the data types used in the process or generated by the process, physical location of the data, current security levels of the data, etc.

A content-based sensitivity estimator component (323) determines the sensitivity level of the content of the data using text and data mining technologies. For each data item (e.g., a email message or a document or a database table), the content-based sensitivity estimator component (123) conducts content analysis and classification to identity the content type and subsequently the sensitivity level. For example, the content-based sensitivity estimator component (323) identifies if a document contains intellectual property (IP), personally identifiable information (PII) or personal health information (PHI), and produces the sensitivity level based on various content and context information. For instance, a document containing 100 credit card numbers is likely to receive a higher sensitivity level than a document with 1 credit card number.

A data sensitivity calculator component (324) combines the estimated data sensitivities generated by the metadata-based sensitivity estimator (321), the process-based sensitivity estimator (322) and the content-based sensitivity estimator (323) and generates a sensitivity (105) for the given data. Various combination techniques can be used to combine the sensitivities such as selecting the highest value, the average value, etc. In a preferred embodiment, a classifier weighted mean is used in which the estimated sensitivities are fed into a regression analysis together with the confidence values of the estimators (i.e., how accurately an estimator has predicted data sensitivity in the past) to produce a final data sensitivity.

Referring again to FIG. 2, classifiers are determined for data categories (block 203) from a defined list of data categories and types (201), which are valuable, e.g., for business or regulations.

At block 202, relative sensitivities are assigned to each category or rank-order the categories by sensitivity.

Let T={T₁, . . . , Tₙ} be the list of data categories and types, and at block 203 for each category, Tᵢ, there are one or more classifiers that collectively decide if a given data item belongs to Tᵢ.

At block 205, let Cᵢ be the set of classifiers for Tᵢ and C={C₁, . . . , Cₘ} be the list of all software programs or classifiers. Thus, the exemplary method outputs a set of classifiers Cᵢ for Tᵢ.

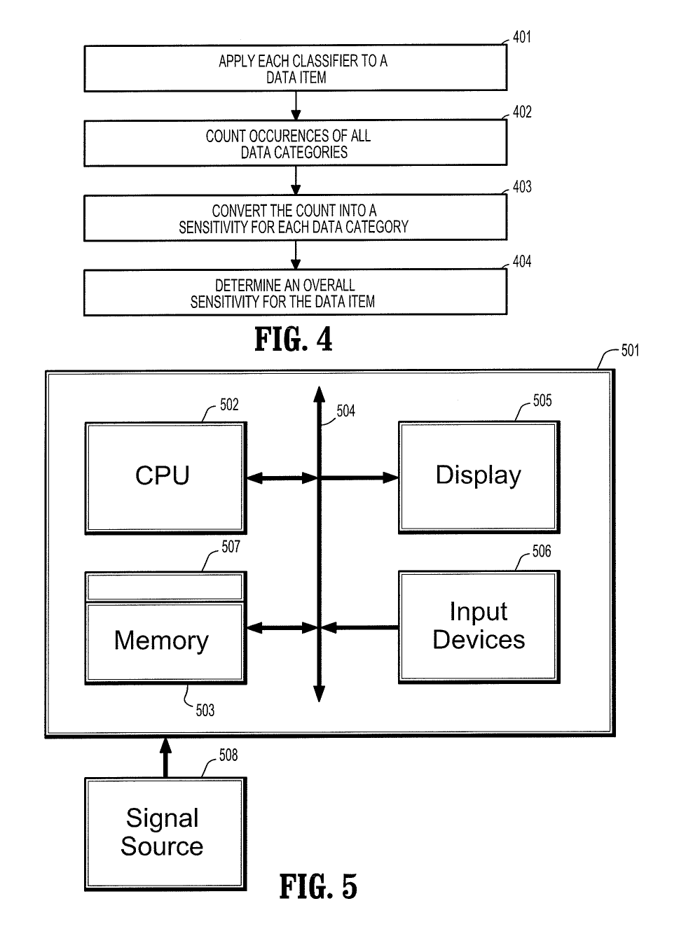

An exemplary method for determining a sensitivity level of a data item is shown in FIG. 4 (see also block 206 of FIG. 2). For a given data item d, where d can be a document, an email message, a database entry, etc.:

At block 401, apply all CᵢεC on d.

At block 402, count the number of occurrences of all data types Tᵢ found in d. The count is a real number greater or equal to 0. For some data types or topics, the count can be either 1 or 0, e.g., if d is a patent disclosure (1) or not (0).

At block 403, the sensitivity of the document d is determined based on the counts of data categories and their ranks or relative values provided by SMEs. An exemplary method for determining the value of the data d to combine all category values found in d. Let c₁ be the count of category T₁ found in d, and let v₁ be the relative sensitivity of T₁ provided at Step 202, then d can be considered to have c₁×v₁ value for T₁. Suppose d has k categories, Ti, . . . , Ti, then the total sensitivity of d is

$${\sum }_{i = 1}^{k} ( {c}_{i} \times {v}_{i} )$$

Another exemplary method for determining the value includes normalizing all sensitivities into a range of values, e.g., [0,1], and to combine the normalized values. In other words, for all data types TᵢεT, the sensitivity of Tᵢ in d can be normalized into a value between 0 and 1.

In the present exemplary embodiment, a logistic (or sigmoid) function is used for the normalization, but other functions are also applicable. The logistic function may be defined as:

$$f ( x ) = \frac{1}{1 + {e}^{- x}} ,$$

where x is determined based on the count and its relative sensitivity. A logistic function is defined for each Tᵢ.

Optionally, the output of all data sensitivities from block 206 may be used to generate representations of the enterprise's data sensitivities. For example, this output may show the distribution of data sensitivity by machine, by user, by geography, or by organization within the business. This would allow a business manager, for example, to view areas in the enterprise that are at high risk because of excessive concentrations of sensitive data, or to find individuals who may have inappropriate levels of sensitive data on insufficiently protected machines. This output may be numeric or, in a preferred embodiment, displayed interactively as graphs, maps, or other visual representations that can be manipulated to see the data at varying levels of granularity as desired. This can be done using a variety of commercially available systems.

At block 404, all the sensitivities are determined at block 403 are combined and the aggregated value is set as the sensitivity level of d (105). This is also shown in the loop of FIG. 2, wherein sensitivity is calculated 206 for data items until a sensitivity of each data item is determined (207).

As will be appreciated by one skilled in the art, aspects of the present disclosure may be embodied as a system, method or computer program product for estimating the sensitivities of data in an organization. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring to FIG. 5, according to an embodiment of the present disclosure, a computer system 501 for implementing a method for estimating the sensitivities of data in an organization can comprise, inter alia, a central processing unit (CPU) 502, a memory 503 and an input/output (I/O) interface 504. The computer system 501 is generally coupled through the I/O interface 504 to a display 505 and various input devices 506 such as a mouse and keyboard. The support circuits can include circuits such as cache, power supplies, clock circuits, and a communications bus. The memory 503 can include random access memory (RAM), read only memory (ROM), disk drive, tape drive, etc., or a combination thereof. Embodiments of the present disclosure can be implemented as a routine 507 that is stored in memory 503 and executed by the CPU 502 to process the signal from the signal source 508. As such, the computer system 501 is a general-purpose computer system that becomes a specific purpose computer system when executing the routine 507 of the present disclosure.

The computer platform 501 also includes an operating system and micro-instruction code. The various processes and functions described herein may either be part of the micro-instruction code or part of the application program (or a combination thereof) that is executed via the operating system. In addition, various other peripheral devices may be connected to the computer platform such as an additional data storage device and a printing device.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Having described embodiments for estimating the sensitivity of data in an organization, it is noted that modifications and variations can be made by persons skilled in the art in light of the above teachings. It is therefore to be understood that changes may be made in exemplary embodiments of disclosure, which are within the scope and spirit of the disclosure as defined by the appended claims. Having thus described an invention with the details and particularity required by the patent laws, what is claimed and desired protected by Letters Patent is set forth in the appended claims.

1-19. (canceled)

20. A computer readable storage medium embodying instructions executed by a processor to perform a method for estimating the sensitivity of data comprising:
defining a plurality of data categories;
determining a relative sensitivity of each of the data categories;
receiving one or more classifiers for associating data items with one or more of the data categories;
receiving a plurality of data items to be valued;
associating one or more of the data categories with each of the data items; and
determining a respective sensitivity for each of the data items according to the relative sensitivity of associated data categories.

21. The computer readable storage medium of claim 20, wherein determining the relative sensitivity of the data categories further comprises executing an interview tool.

22. The computer readable storage medium of claim 20, wherein determining the relative sensitivity of the data categories further comprises:
receiving a rank-order of the data categories;
combining the rank orders of the data categories to create an overall rank order; and
receiving an assignment of a relative score to each of the data categories in the overall rank order of the data categories.

23. The computer readable storage medium of claim 20, wherein receiving the data items to be valued further comprises at least one of crawling a plurality of files on a plurality of computer systems and receiving a plurality of files via network communications.

24. The computer readable storage medium of claim 20, wherein receiving the data items to be valued further comprises prioritizing the data items.

25. The computer readable storage medium of claim 24, wherein prioritizing the data items further comprises:
collecting metadata information from the plurality of input data items; and
removing from the plurality of input data items those data items where the metadata does not match one or more of a plurality of predetermined metadata values.

26. The computer readable storage medium of claim 24, wherein prioritizing the data items further comprises selecting ones of the input data items having sensitivities within a preselected range.

27. The computer readable storage medium of claim 24, wherein prioritizing the data items further comprises:
selecting processes in a target organization; and
utilizing the subset of the input data items related to the selected processes.

28. The computer readable storage medium of claim 27, wherein selecting the processes in the target organization further comprises discovering processes from activity logs corresponding to the selected process.

29. The computer readable storage medium of claim 27, wherein selecting the processes in the target organization further comprises determining a sensitivity level of a process of a target organization by applying a graph analysis using at least one of a number of in-degree links to a process node of the process, a number of out-degree links from the process node of the process, a frequency of the process being executed, job roles in the process, the data categories used in the process or generated by the process, physical location of the data items used in the processes, and a current security level of the data items used in the process.

30. The computer readable storage medium of claim 24, wherein prioritizing the data items further comprises mining processes of a target organization, relationships between the processes and data resources used in the processes.

31. The computer readable storage medium of claim 24, wherein prioritizing of the data items further comprises:
determining the categories of the data items according to the one or more classifiers identifying the content category of the data item; and
discarding data items not belonging to a predetermined set of categories.

32. The computer readable storage medium of claim 20, wherein determining the sensitivity for each of the data items further comprises at least one of estimating data sensitivity based on metadata information of each data item, estimating the data sensitivity based on the business processes involving the data items, and estimating the data sensitivity based on the content of the data item.

33. The computer readable storage medium of claim 20, the method further comprising:
applying the one or more classifiers to the data items;
counting a number of occurrences of each of the data categories found in each of the data items;
determining the respective sensitivities of the data items with respect to the data category based on the number of occurrences and the sensitivity of each of the data categories found in the data items; and
setting an aggregated sensitivity value as the sensitivity of the data items.

34. The computer readable storage medium of claim 33, the method further comprising normalizing the sensitivity for each of the data categories into the same range of values.

35. The computer readable storage medium of claim 32, wherein estimating the data sensitivity based on the business processes further comprises:
determining a sensitivity of each of a plurality of processes consuming the data items; and
determining the respective sensitivity for each of the data items according to the sensitivity of the process determined for each of the data items.

36. The computer readable storage medium of claim 35, further comprising:
determining a relationship among the processes according to dependencies among the processes; and
updating the sensitivity of at least one process according to dependencies among the plurality of processes.

37. The computer readable storage medium of claim 32, wherein estimating the data sensitivity based on the metadata information further comprises:
determining the sensitivities of the metadata of the data items; and
determining the respective sensitivity for each of the data items according to the sensitivities of the metadata information.

38. A system for evaluating data comprising:
a memory device storing a plurality of instructions embodying the system for evaluating data; and
a processor for receiving a plurality of data items to be valued and a plurality of data categories and executing the plurality of instructions to perform a method comprising:
determining a relative sensitivity of each of the data categories;
receiving one or more classifiers for associating data items with one or more of the data categories;
receiving a plurality of data items to be valued;
associating one or more of the data categories with each of the data items; and
determining a respective sensitivity for each of the data items according to the relative sensitivity of associated data categories.

39. A method in a computer system for generating estimates for sensitivity of data, the method comprising:
defining a plurality of data categories;
determining a relative sensitivity of each of the data categories;
receiving one or more classifiers for associating data items with one or more of the data categories;
receiving a plurality of data items to be valued;
associating one or more of the data categories with each of the data items; and
determining a respective sensitivity for each of the data items according to the relative sensitivity of associated data categories.

40. The method of claim 39, wherein assigning the relative sensitivity to each of the data categories further comprises:
receiving a rank-order of the data categories;
combining the rank orders of the data categories to create an overall rank order; and
receiving an assignment of a relative score to each of the data categories in the overall rank order of the data categories.
